(19) United States
(12) Patent Application Publication
(10) Pub. No.: US 2022/0373202 A1
(43) Pub. Date: Nov. 24, 2022

(54) FAN POWERED AIR FILTRATION UNIT

(71) Applicant: Healthway Home Products Company Inc., Pulaski, NY (US)

(72) Inventors: Vincent G. Lobdell, SR., Pulaski, NY (US); Mitchell Raymond Lobdell, Constantia, NY (US); Xuchen Wang, Pulaski, NY (US); Kevin GUERNSEY, Constantia, NY (US); Alexander Thomas Frechette, Mexico, NY (US); Timothy George Cusack, Central Square, NY (US); Brooke Alan Rowe, Vernon, NY (US)

(21) Appl. No.: 17/747,840

(22) Filed: May 18, 2022

Related U.S. Application Data
(60) Provisional application No. 63/190,542, filed on May 19, 2021.

(51) Int. Cl. F24F 8/192; F24F 13/28; F24F 11/89; F24F 1/0071

(52) U.S. Cl. CPC F24F 8/194; F24F 13/28; F24F 11/89; F24F 1/0071; F24F 2110/50

(57) ABSTRACT

The present disclosure is directed methods and apparatus that improve the energy efficiency of an air filtration apparatus while maintaining a high level of filtration capabilities. Air filtration apparatus consistent with the present disclosure may include an input, a fan, a pre-filter, and electrical conductors that provide a high voltage used to charge particles in an air flow. This apparatus may also include a secondary filter that traps charged particles. The pre-filter may filter air using conventional means, where a high energy electric field generated by high voltage conductors may charge particles in the air such that those particles may clump together and be captured in the secondary filter. These clumping effects may allow a less dense filter media to capture particles that would otherwise pass through the less dense filter. Micro-organisms attached to the captured particles may be degraded or destroyed after they are captured in the secondary filter.

### CROSS-REFERENCE TO RELATED APPLICATIONS

The present application claims the priority benefit of U.S. provisional application No. 63/190,542 filed May 19, 2021, the disclosure of which is incorporated herein by reference.

### BACKGROUND

### Field of the Disclosure

The present disclosure is generally related to a fan-powered air filtration apparatus and methods for operating the fan-powered air filtration apparatus. More specifically the present disclosure is related to increasing the energy efficiency of an air filtration apparatus while maintaining a high level of filtration capabilities.

### Description of the Related Art

Many conventional air filtration apparatus rely upon the use of a fine dense filter commonly referred to as high efficiency particular air filter or a HEPA filter to remove fine particles from the air. These conventional filters consume high levels of electrical power because the density of these HEPA filters. This is because very small openings of a HEPA filter constrain or provide resistance to air moving though the HEPA filter. Because of these small openings, HEPA filters need to be replaced when the small openings are clogged with fine particles.

Pre-filters may also be used to remove larger particles and may increase the effective lifespan of a secondary filter filters. A pre-filter may reduce the load placed on a filtration system caused by a pressure drop. Pre-filters should be replaced more frequently than the electrically enhanced filters, and failure to do so may limit the effectiveness of the air filtration system and increase the pressure drop load placed on the filtration system. Pressure drops caused by both pre-filters and the primary filter media may strain a filtration system and results in increased power consumption, increased energy costs, and increased noise.

To mitigate such high power consumption, high energy costs and increased noise, what are needed are new air filtration method and apparatus that can capture fine particles and live organisms while minimizing pressure drops, power consumption, and noise produced by the filtration system.

### SUMMARY OF THE PRESENTLY CLAIMED INVENTION

The present invention is directed to an air filtering apparatus or a method for operating the filtering apparatus. In a first embodiment a filtering apparatus includes a blower that receives air from an area outside of a room, wherein operation of the blower results in the air from the area outside of the room being sucked into the air filtration apparatus, and a front ground control grid; a rear control grid. This filtering apparatus may also include a conductor disposed between the front control grid and the rear control grid. Here the conductor may receives a high voltage such that air disposed between the front control grid and the rear control grid is exposed to a high energy field when the high voltage is received by the conductor.

In a second embodiment, the presently claimed method may include providing an air flow based on operation of a blower. Here the blower may suck air into the air filtering apparatus from an area located outside of a room. Air passed through portions of the air filtering apparatus may passes through a front control grid and a rear control grid when a conductor disposed between the front control grid and the rear control grid receives a high voltage such that air disposed between the front ground control grid and the rear ground control grid is exposed to a high energy field. This high energy field may be generated from based on the high voltage received by the conductor. A filter element disposed between the front control grid and the rear may capture particles that clump together after being exposed to the high energy field.

### DESCRIPTIONS OF THE DRAWINGS

FIG. 1 is a cross-section illustration of a fan-powered air filtration unit.

FIG. 2A and FIG. 2B illustrates a filter apparatus where filters contained within the apparatus may be accessed and changed from within a room that requires filtered air.

FIG. 3 illustrates a portion of the air filter apparatuses of FIG. 1, FIG. 2A, and FIG. 2B that include parts that provide a high energy field and the isolate that field from external parts of an air filter apparatus.

FIG. 4 illustrates a set of curves of amperage drawn by filtering apparatus that use high efficiency particular air (HEPA) filters as compared to filtering apparatus that use an electric field.

FIG. 5 illustrates a set of curves of power consumption in Watts of a filtering apparatus that use HEPA filters as compared to a filtering apparatus that use an electric field.

FIG. 6 illustrates a computing system that may be used to implement an embodiment of the present invention.

### DETAILED DESCRIPTION

The present disclosure is directed methods and apparatus that improve the energy efficiency of an air filtration apparatus while maintaining a high level of filtration capabilities. Air filtration apparatus consistent with the present disclosure may include an input, a fan, a pre-filter, and electrical conductors that provide a high voltage used to charge particles in an air flow. This apparatus may also include a secondary filter that traps charged particles. While the pre-filter may filter air using conventional means, a high energy electric field generated by the high voltage conductors may charge particles in the air such that those particles may cluster or clump together and be captured in the secondary filter. These clumping effects may allow a less dense filter media to capture smaller particles that would otherwise pass through the less dense filter. Once captured, any micro-organisms attached to the captured particles are exposed to the high energy electric field when those micro-organisms (fungi, bacteria, and/or viruses) are degraded or destroyed by the presence of the high energy electric field. This process of degrading or destroying micro-organisms may be referred to as microbiostatic process.

Cleanrooms, and other areas where air quality is important frequently have fan-powered air filtration units mounted in the ceiling of a room. These units may frequently have a blower motor driving air through a dense filter media, such as a high efficiency particular air (HEPA) filter, to achieve the level of first-pass efficiency necessary for the given application. While fan-powered air filtration units that use dense filter media can achieve a desired high filtration capacity, they typically exhibit higher levels of noise, pressure drops, and energy consumption as compared to systems using less dense filter media.

A disinfecting filtration system (DFS), also referred to as electrically enhanced filtration (EEF), is an air purification system that uses two mechanisms to maintain high air cleaning performance. The DFS high energy field creates a self-contained, highly ionized state in the main filter that aggregates or clusters ultrafine particles to make them larger, allowing the main filter to effectively capture ultrafine particles. The high energy field is controlled and self-contained between an entry ground control grid before the main filter and a rear control grid affixed to the rear of the main filter. All ions generated by the high energy field are isolated in the main filter between an entry (front) control grid and exhaust (rear) control grid on the rear of the filter, not allowing ions to exhaust the DFS system. The controlled, isolated high energy field generated by the DFS continually creates high energy exposure through the pleats and fibers of the main filter creating microbiostasis (“prevention of organism growth”) in the main filter. This helps prevent live organisms from escaping back into the air. These two mechanisms work together to provide the ultraclean filtration of particles and continual prevention of organism growth in the DFS filter.

Pre-filters may also be used to remove larger particles. These pre-filters may increase the effective lifespan of electrically enhanced filters and reduce a load placed on a filtration system caused by a pressure drop. Pre-filters should be replaced more frequently than the electrically enhanced filters, and failure to do so may limit the effectiveness of the air filtration system and increase the pressure drop load placed on the filtration system. Pressure drops caused by both pre-filters and the primary filter media puts strain on a filtration system and results in increased power consumption and noise.

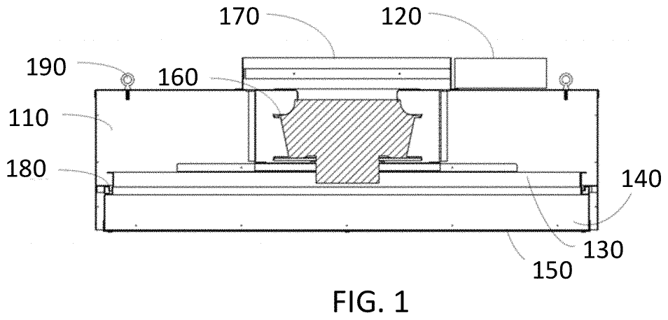

FIG. 1 is a cross-section illustration of a fan-powered air filtration unit. The fan-powered air filtration unit (FFU) 110 may be a ceiling-mounted air filtration system, such as those used in cleanrooms, where air passes through a filter and into a room through ceiling panels. This unit may allow for room side replacement of a filter media 140.

Air filtration unit 110 may include a control unit 120 that activates a high energy field by delivering energy to a front ground control grid 130. This high energy field may be an electric field generated when a high voltage is applied to a high energy wire (not shown in FIG. 1). The control unit 120 may be mounted on the exterior of the fan-powered air filtration unit 110 as shown in FIG. 1. In other instances, control unit 120 may be placed inside of air filtration unit 110. Alternatively, control unit 120 may be located remotely. A single control unit 120 may be used to control the operation of multiple fan-powered air filtration units 110.

The front ground control grid 130 may be located near an input or intake side of a filter media 140. The front ground control grid 130 may be connected to an Earth ground connection and an electrostatic field may be generated by energizing a high wire with a high voltage. This electrostatic field may propagate through the filter media 140. When the air filtration unit 110 is in operation, 0.002-micron diameter and larger particles may be captured and any micro-organisms attached to those particles may be degraded or destroyed based on the high energy field generated by the high voltage provided to the high voltage wire. Exemplary voltages includes a voltage of, 5 thousand kilo-volts (KV) to 16 KV or more in order to generate a high energy field when the high energy wire is energized. The high-energy transfer grids cover 95% of the filter media 140 area while only slightly increasing the resistance of a filter media 140.

Embodiments may include filter media 140. The filter media 140 may be a less dense media (for example, 97 DOP) compared to the standard high efficiency particular air (HEPA) filter (99.97 DOP). The use of a less dense filter media 140 allows the fan-powered air filtration unit 110 to have a higher gram holding weight and allows for more dust holding capacity than a standard HEPA filter, resulting in increased filter life. HEPA filters also offer higher air flow resistance as compared to this filter media 140. The filter media 140 is continually being exposed to the high energy field, creating a microbiostatis effect in the media. The result, depending on the efficiency of the traditional media used, is as follows: much higher particulate efficiency than traditional media filters and with fan-powered machines, a up to 99.99% at 0.002-micron filtration efficiency, with a greater gram holding weight capacity, resulting in a greater lifetime performance and less maintenance and energy cost. The technology has been proven to enable a penetration reduction of 2-3 orders of magnitude of particles using less power than conventional air filters. Apparatus consistent with the present disclosure may allow for a fan-powered air filtration unit 110 operating at a flow rate of 650 CFM to achieve single-pass efficiency of greater than up to 99.99% down to 0.002 microns with a pressure drop of less than 0.2″ of a water column and an amp draw less than 1.4 amps from a electric blower 160. The filter media 140 may be part of a single assembly that includes a housing around the filter media 140 that may have a gel seal 180 and or a rear ground control grid 150 attached.

Embodiments may include a rear ground control grid 150 that may also be attached to the Earth ground. The rear ground control grid 150 may be replaced with the filter media 140. In one embodiment, the rear ground control grid 150 may be affixed, such as with glue, to the filter media 140. The rear ground control grid 150 also eliminates the electrostatic field effects outside the filter media 140 and allows for the ceiling access panel (not shown) to be free from electrical charge during room side filter replacement.

Such apparatus may include an electric blower 160 that may draw air through the pre-filter 170 and force it through the filter media 140. In one instance, the electric blower 160 may be a centrifugal blower with an aluminum impeller or set of fan blades.

Such apparatus may include a pre-filter 170 that captures large particles before they may enter the electric blower 160. The minimum efficiency reporting value (MERV) rating of the pre-filter 170 may vary based on the application. In one embodiment the MERV rating is at least MERV 8. The minimum size of particles captured by the prefiltration process can vary depending upon the application and the resistance to the air flow capacity of the HVAC system.

In certain instances, filter apparatus may include a gel seal 180 that may form an airtight seal around the filter media 140 so that all air is directed into the room is forced to travel through the electrostatic field and the filter media 140. The gel seal 180 may be a soft silicone gel in a trough that surrounds the filter media 140. In one embodiment, there may be a ridge that extends down from the fan-powered air filtration unit 110 housing that may sit in the gel seal 180 to form an airtight seal. The gel seal 180 may be made from a material other than silicon or may be another type of gasket well known in the art. Instead of a gel seal, item 180 may be a gasket that forms a seal when the assemble of FIG. 1 is assembled.

In operation, blower 160 may pull air from above the filter apparatus, through pre-filter 170, and blower 160 may provide an air stream to a room after passing through the high energy field and filter media 140. Embodiments may include some number of lifting eyebolts 190 that may be used to secure the fan-powered air filtration unit 110 in place.

Note that the air filtration unit 110 may be mounted within a ceiling or wall (i.e. the structure of a room) that is parallel to a longer side of pre-filter 170, front ground control grid 130, filter media 140, and rear control grid 150 forming an in-line assembly.

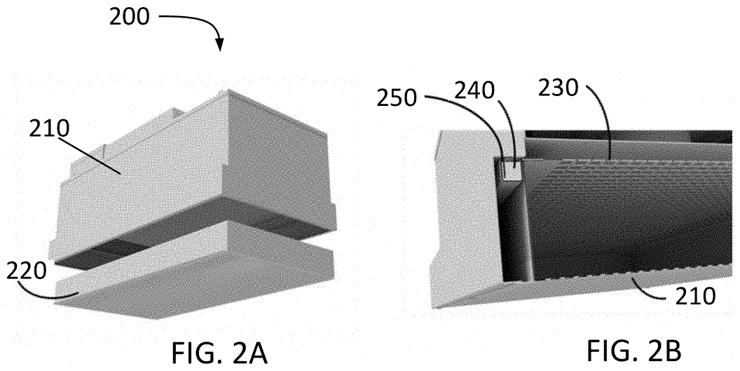

FIG. 2A and FIG. 2B illustrates a filter apparatus where filters contained within the apparatus may be accessed and changed from within a room that requires filtered air. The filter apparatus 200 of FIG. 2A includes filter media receiver 220 that receives a set of filter media. This filter media may be replaced by simply removing filter media receiver 220, removing an old set of filter media, replacing the old filter media with a new set of filter media, and reattaching the filter media receiver 220 back on the filter apparatus. In this embodiment, the filter media is part of a filter assembly that includes the rear ground control grid 150 and the gel seal 180 of FIG. 1. FIG. 2B shows a cross-section of the filter assembly in the fan-powered air filtration unit 210. FIG. 2B includes sealing ridge 250 is part of the housing on the fan-powered air filtration unit 110 that fits into the gel seal 240 to create the airtight seal in order to provide an effective amount of air filtration. Quarter-turn screws or other fasteners may be used to secure the filter receiver assembly 220 to make the room side replacement of the filter assembly quick and easy. FIG. 2B also illustrates front control grid 230 that helps electrically isolate outer parts of the air filter apparatus 200 from high energy fields generated inside of the air filter apparatus 200.

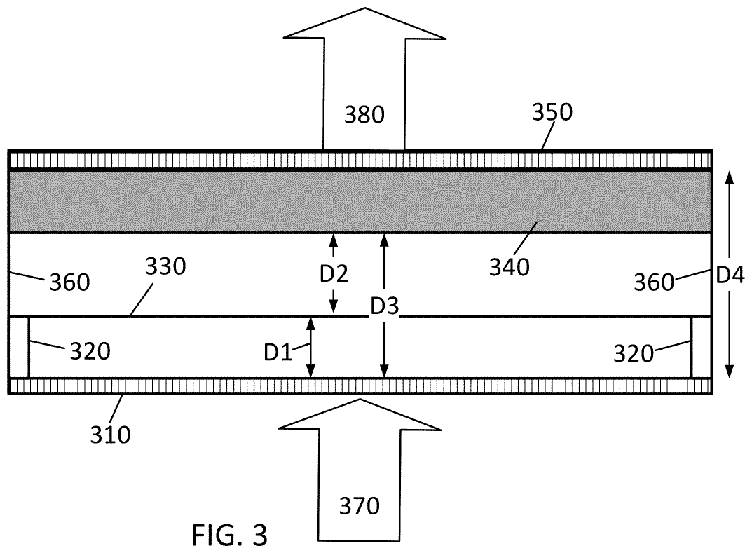

FIG. 3 illustrates a portion of the air filter apparatuses of FIG. 1, FIG. 2A, and FIG. 2B that include parts that provide a high energy field and the isolate that field from external parts of an air filter apparatus. FIG. 3 includes front control grid 310, insulators 320, high energy wire 330, filter media 340, and rear control grid 350. Large arrow 370 illustrates a flow of air moving into front control grid 310 and large arrow 380 illustrates filtered air moving past rear control grid 350. Note that while FIG. 3 illustrates air flows 370 and 380 moving from a lower part to a higher part of a filter assembly, the filter assembly of FIG. 3 may be rotated 180 degrees when mounted in a ceiling configuration. Such a ceiling configuration allows for air to enter a filter apparatus from above the filter apparatus filtered and then the filtered air may exit the filter apparatus from the ceiling of a room.

Both front ground control grid 310 and rear control grid 350 will typically be grounded such that these control grids will not become electrically charged. Wire 330 may be energized with a high voltage to form a high energy field within areas where arrows D1, D2, D3, and D4 are located. Arrow D1 indicates a distance between from front control grid 310 to wire 330. Arrow D2 indicates a distance between wire 330 and filter media 340. Distances D1 plus D2 equal distance D3. Note that in FIG. 3 distance D1 is a shorter distance than distance D2. By making distance D1 shorter than distance D2, any electric arcing between wire 330 and a ground connection will more likely arc to the front control grid 310 and not the rear control grid 350. Such a design will help prevent arcing from damaging filter media 340. Distance D4 may be identified by adding distances D1, D2, D3, and a thickness of filter media 340. In operation, insulators 320 electrically isolate high energy wire 330 from other parts of the filter assembly.

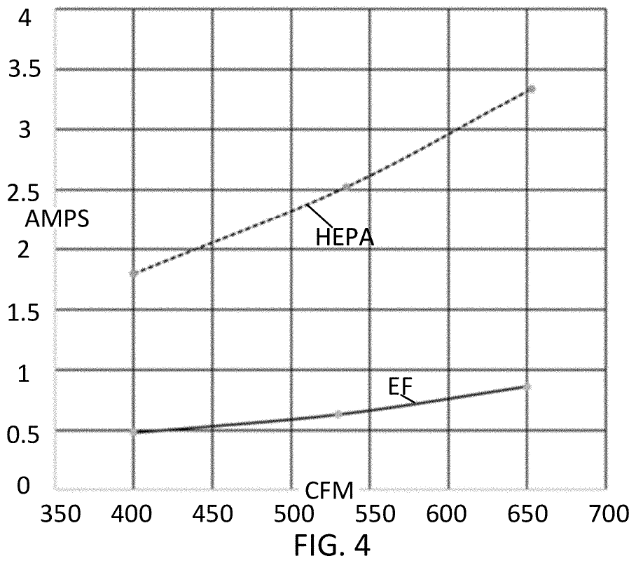

FIG. 4 illustrates a set of curves of amperage drawn by filtering apparatus that use HEPA filters as compared to filtering apparatus that use an electric field. Even though the HEPA filter may be a denser filter than a filter apparatus that use high energy electric fields, the curves of FIG. 4 correspond to different filtering apparatus that may have a same filtering capability. This is because the high energy field results in the clumping and capture of small particles.

FIG. 4 includes a graph with a horizontal axis of air flow rate in cubic feet per minute (CFM) and a vertical axis of amperage (amps) drawn when a HEPA filter was used. FIG. 4 also illustrates a number of amps drawn when a high energy electric field (EF) was used. Here the top HEPA curve corresponds to amps drawn by the HEPA filter configuration and the bottom EF curve corresponds to amps drawn by the high energy field filtering configuration. The apparatus associated with the top HEPA curve draws more current (i.e. amps) the apparatus associated with the bottom EF curve for a same air flow rate (CFM). The high energy field configuration draws about 0.5 amps at an air flow rate of 400 CFM where the HEPA configuration draws about 1.8 amps for the same 400 CFM air flow rate. FIG. 4 also shows that the EF configuration draws about 1.0 amps at 650 CFM and that the HEPA configuration draws about 3.7 amps at 650 CFM. The HEPA curve is much steeper than the EF curve. This means that the energy efficiency of the HEPA configuration is much more sensitive to flow rate than the EF configuration.

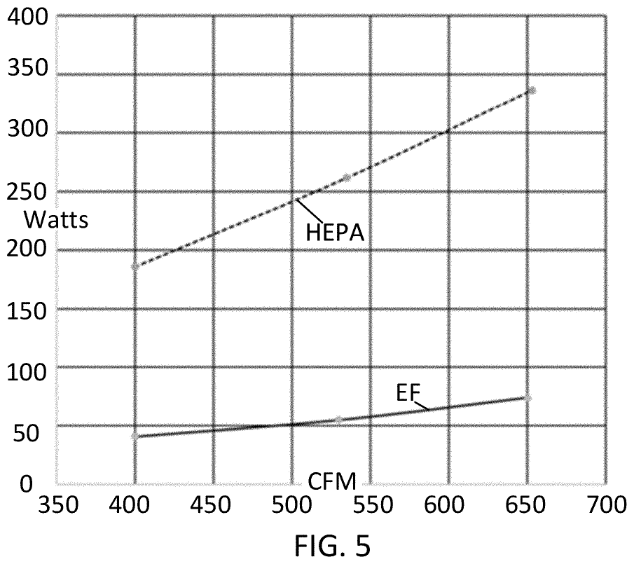

FIG. 5 illustrates a set of curves of power consumption in Watts of a filtering apparatus that use HEPA filters as compared to a filtering apparatus that use an electric field. Even though the HEPA filter may be a denser filter than a filter apparatus that use high energy electric fields, the curves of FIG. 5 correspond to different filtering apparatus that may have a same filtering capability. This is because the high energy field results in the clumping and capture of small particles.

FIG. 5 includes a graph with a horizontal axis of air flow rate in cubic feet per minute (CFM) and a vertical axis of power consumed (Watts) when a HEPA filter was used and power consumed (Watts) drawn when a high energy electric field (EF) was used. Here the top HEPA curve corresponds to power consumed by the HEPA filter configuration and the bottom EF curve corresponds to power consumed by the high energy field filtering configuration. The apparatus associated with the top HEPA curve consumes more power than the apparatus associated with the bottom EF curve for a same air flow rate (CFM). The high energy field configuration consumes about 40 Watts at an air flow rate of 400 CFM where the HEPA configuration consumes about 180 Watts for the same 400 CFM air flow rate. FIG. 5 also shows that the EF configuration consumes about 95 Watts at 650 CFM and that the HEPA configuration consumes about 349 Watts at 650 CFM. Here again, the HEPA curve is much steeper than the EF curve. This means that the energy efficiency of the HEPA configuration is much more sensitive to flow rate than the EF configuration. The use of an high energy field in the in-line air filtrations unit should easily be able to provided 99.97% single pass efficiency when filtering out particles as small as 0.3 microns when the air filtration unit consumes less than 190 Watts at a an air flow rate of 650 CFM and will be able to perform such a filtration capacity when the air filtration unit consumes less than 80 Watts at an air flow rate of 400 CFM.

Methods of the present disclosure may include controlling an air flow based on a speed of a blower. Here the blower may suck air into the air filtering apparatus from an area located outside of a room. Air passed through portions of the air filtering apparatus may pass through a front control grid and a rear control grid when a conductor disposed between the front control grid and the rear control grid receives a high voltage such that air disposed between the front ground control grid and the rear ground control grid is exposed to a high energy field. This high energy field may be generated from on the high voltage received by the conductor. A filter element disposed between the front control grid and the rear may capture particles that clump together after being exposed to the high energy field.

This method may also include passing the air located on the outside of the room through a pre-filter that generates pre-filtered air. The pre-filtered air may then be passed through the front control grid when that pre-filtered air is exposed to the high energy field. An air filter apparatus may include a set of sensors that provide data to a processor that executes instructions out of a memory. The processor may identify when particles in the air have density greater than a threshold level, and the processor may increase or decrease the voltage applied to the conductor to increase or decrease a strength of the high energy field. Sensor data may also be used to identify when an air flow rate should be changed. For example, the air flow rate may be changed based on a current particular level that may correspond to a particle count measured in parts per million (PPM).

The voltage may be decreased after a particle count changes below the threshold level. Alternatively, or additionally the voltage may be decreased when sensor data indicates that arcing is occurring between the conductor another part (e.g. the front control grid) of the filtering apparatus. Voltages and pressure drops of an air filtering apparatus may be controlled based on a set of rules that are associated with received sensor data. These rules may also be associated with various conditions, particle count above a threshold level, an observed pressure drop, arcing, a smell, or other conditions that affect operation of the filtering apparatus.

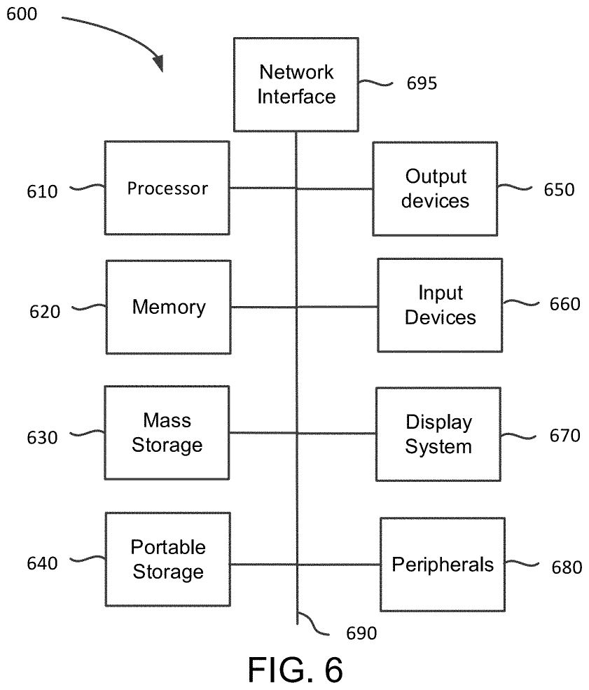

FIG. 6 illustrates a computing system that may be used to implement an embodiment of the present invention. The computing system 600 of FIG. 6 includes one or more processors 610 and main memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, peripheral devices 680, and network interface 695.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a FLASH memory, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD), a plasma display, an organic light-emitting diode (OLED) display, an electronic ink display, a projector-based display, a holographic display, or another suitable display device. Display system 670 receives textual and graphical information and processes the information for output to the display device. The display system 670 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 680 may include any type of computer support device to add additional functionality to the computer system. For example, peripheral device(s) 680 may include a modem or a router.

Network interface 695 may include any form of computer interface of a computer, whether that be a wired network or a wireless interface. As such, network interface 695 may be an Ethernet network interface, a BlueTooth™ wireless interface, an 802.11 interface, or a cellular phone interface.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 600 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A disinfecting air filtration apparatus, the apparatus comprising:
a blower that receives air from an area outside of a room, wherein operation of the blower results in the air from the area outside of the room being drawn into the air filtration apparatus;
a front ground control grid;
a rear control grid; and
a conductor disposed between the front control grid and the rear control grid, wherein the conductor receives a high voltage such that air disposed between the front control grid and the rear control grid is exposed to a high energy field when the high voltage is received by the conductor.

2. The apparatus of claim 1, further comprising an exchangeable filter media that is exposed to the high energy field.

3. The apparatus of claim 2, wherein the high energy field results in charging particles in the air disposed between the front control grid and the rear control grid such that those particles clump together and are captured by the filter media.

4. The apparatus of claim 2, further comprising a pre-filter that filters the air from the area outside of the room to generate pre-filtered air, wherein the pre-filtered air passes through the front control grid based on operation of the blower and a longer side of the pre-filter, the front ground control grid, the exchangeable filter media, and the rear control grid are parallel a surface of a room.

5. The apparatus of claim 4, further comprising an insulator that electrically insulates the conductor from at least one other part of the apparatus, wherein the structure of the room is a ceiling of the room and operation of the apparatus results in a filtration capacity of 99.97% single pass efficiency when capturing particles of 0.3 microns when consuming no more than 190 Watts at an air flow rate of 650 cubic feet per minute (CFM) and when consuming no more than 80 Watts at an air flow rate of 400 CFM.

6. The apparatus of claim 2, further comprising a seal that prevents the air disposed between the front control grid and the rear control grid from bypassing the exchangeable filter media.

7. The apparatus of claim 2, further comprising a mechanical connector that attaches a sub-assembly that contains the exchangeable filter media when the apparatus is in operation.

8. The apparatus of claim 1, wherein the conductor is a wire.

9. The apparatus of claim 1, further comprising:
a memory;
a processor that executes instructions out of the memory; and
one or more sensors that provide sensor data to the processor.

10. A method for filtering air, the method comprising:
sucking air into an air filtering apparatus from an area outside of a room based on operation of a blower, wherein an air flow passes through a front control grid and a rear control grid when a conductor disposed between the front control grid and the rear control grid receives a high voltage such that air disposed between the front control grid and the rear control grid is exposed to a high energy field based on the high voltage received by the conductor; and
capturing particles charged by the high energy field in a filter element.

11. The method of claim 10, wherein the filter element is an exchangeable filter media that is exposed to the high energy field such that the charged particles clump together resulting in a filtration capacity of 99.97% single pass efficiency when capturing particles of 0.3 microns when consuming no more than 190 Watts at an air flow rate of 650 cubic feet per minute (CFM) and when consuming no more than 80 Watts at an air flow rate of 400 CFM.

12. The method of claim 10, further comprising allowing the air from the area outside of the room to pass through a pre-filter when pre-filtered air is filtered, wherein the pre-filtered air passes through the front control grid based on operation of the blower.

13. The method of claim 10, wherein an insulator electrically insulates the conductor from at least one other part of the apparatus.

14. The method of claim 11, wherein a seal prevents the air disposed between the front control grid and the rear control grid from bypassing the exchangeable filter media.

15. The method of claim 11, wherein a mechanical connector attaches a sub-assembly that contains the exchangeable filter media when the apparatus is in operation.

16. The method of claim 10, wherein the conductor is a wire.

17. The method of claim 10, wherein a processor that executes instructions out of a memory receives sensor data from a sensor based on a condition associated with the sensor data received from the sensor.

18. The method of claim 17, further comprising increasing the high voltage according to a rule associated with the condition associated with the received sensor data.

19. The method of claim 18, further comprising:
receiving additional sensor data from the sensor;
identifying that the condition is no longer present based on an evaluation of the additional sensor data; and
decreasing the high voltage according to the rule based on the condition no longer being present.

20. The method of claim 18, further comprising:
receiving sensor data from a sensor;
performing an evaluation by a processor that executes instructions out of a memory;
identifying a condition associated with an operational rule of the air filtering apparatus; and
changing an air flow rate according the operation rule based on the condition being identified.
